(19) United States
(12) Patent Application Publication
(10) Pub. No.: US 2012/0310936 A1
(43) Pub. Date: Dec. 6, 2012

(54) METHOD FOR PROCESSING DUPLICATED DATA

(75) Inventors: Ming-Sheng Zhu, Tianjin (CN); Chih-Feng Chen, Taipei (TW)

(73) Assignee: INVENTEC CORPORATION, Taipei (TW)

(21) Appl. No.: 13/239,913

(22) Filed: Sep. 22, 2011

(30) Foreign Application Priority Data
Jun. 2, 2011 (CN) 201110158164.3

(51) Int. Cl. G06F 17/30

(52) U.S. Cl. 707/737; 707/E17.089

(57) ABSTRACT

A processing method for duplicated data includes the following steps. A stored file is partitioned into a plurality of raw tanks and a plurality of meta tanks, in which the raw tanks correspond to the meta tanks in a one to one manner, and each meta tank has a stored fingerprint value of the corresponding raw tank. A duplicated data determination request is received, in which the duplicated data determination request includes a requested fingerprint value. At least one of the meta tanks is read, and the requested fingerprint value is compared with the stored fingerprint value of the read meta tank. A referred counter value of the read meta tank is modified, and the modified meta tank is stored back, when the requested fingerprint value is the same as the stored fingerprint value of the read meta tank.

### CROSS-REFERENCE TO RELATED APPLICATIONS

This non-provisional application claims priority under 35 U.S.C. §119(a) on Patent Application No. 201110158164.3 filed in China, P.R.C. on Jun. 2, 2011, the entire contents of which are hereby incorporated by reference.

### BACKGROUND OF THE INVENTION

1. Field of the Invention

The present invention relates to a method for processing duplicated data, and more particularly to a method for processing duplicated data rapidly.

2. Related Art

Data de-duplication is a data reduction technology and generally used for a disk-based backup system for the main purpose of reducing storage capacity used in a storage system. A working mode of the data de-duplication is searching for duplicated tanks of viable sizes at different locations in different files within a certain period of time. The duplicated tanks may be replaced with an indicator. A large quantity of redundant data always exists in the storage system. In order to solve the problem to conserve more space, a de-duplication technology logically becomes a focus point of people. A de-duplication technology can be adopted to reduce stored data to 1/20 of the original stored data, so as to obtain more backup space, so that not only can backup data in the storage system be saved for a longer time, but also a large amount of bandwidth required in the process of off-line storing can be conserved.

Data to be stored is stored in a server, so a client often needs to transport the data to the server now and then. Then, the server performs a data de-duplication process on the data. However, in order to determine whether the data to be backed up by the client is stored in a disk of the server, a whole relevant tank needs to be loaded into a memory, and then a part of meta data in the whole tank is read. However, no matter the tank is the duplicated data or not, raw data in the tank loaded into the memory is not used.

### SUMMARY OF THE INVENTION

The present invention is a method for processing duplicated data, which comprises the following steps. A stored file is partitioned into a plurality of raw tanks and a plurality of meta tanks, in which the raw tanks correspond to the meta tanks in a one to one manner, and each meta tank has a stored fingerprint value of the corresponding raw tank. A duplicated data determination request is received, in which the duplicated data determination request comprises a requested fingerprint value. At least one of the meta tanks is read, and the requested fingerprint value is compared with the stored fingerprint value of the read meta tank. A referred counter value of the read meta tank is modified, and the modified meta tank is stored back, when the requested fingerprint value is the same as the stored fingerprint value of the read meta tank.

Each raw tank comprises a plurality of raw chunks, each meta tank comprises a plurality of meta chunks, and the raw chunks correspond to the meta chunks in the one to one manner.

According to an embodiment, the stored file may be stored in a disk of a server, and the modified meta tank may be stored back in the disk.

In the step of reading the at least one meta tank and comparing the requested fingerprint value with the stored fingerprint value of the read meta tank, it is first determined whether the meta tank corresponding to the requested fingerprint value exists in a memory. When the meta tank corresponding to the requested fingerprint value exists in the memory, the meta tank corresponding to the requested fingerprint value in the memory is read, and the requested fingerprint value is compared with the stored fingerprint value of the read meta tank.

In the step of reading the at least one meta tank and comparing the requested fingerprint value with the stored fingerprint value of the read meta tank, when the meta tank corresponding to the requested fingerprint value does not exist in the memory, the meta tank corresponding to the requested fingerprint value is read from the disk into the memory, and the requested fingerprint value is compared with the stored fingerprint value of the read meta tank.

According to another embodiment, some meta tanks is regarded as an allocation group. In the step of reading the at least one meta tank and comparing the requested fingerprint value with the stored fingerprint value of the read meta tank, at least one of the allocation groups is read first, and then the requested fingerprint value is compared with the stored fingerprint value of the meta tank in the read allocation group. A data size of the allocation group may be a positive integer multiple of 16 KB.

Moreover, in the step of modifying the referred counter value of the read meta tank and storing the modified meta tank back, the referred counter value of the read meta tank is modified, and the allocation group corresponding to the modified meta tank is stored back.

### BRIEF DESCRIPTION OF THE DRAWINGS

The present invention will become more fully understood from the detailed description given herein below for illustration only, and thus are not limitative of the present invention, and wherein:

FIG. 1 is a schematic diagram of a server according to an embodiment of the present invention;

FIG. 2 is a flow chart of a method for processing duplicated data according to an embodiment of the present invention;

FIG. 3 is a schematic diagram of a meta chunk and a raw chunk according to an embodiment of the present invention;

FIG. 4 is a flow chart of Step S130 according to an embodiment of the present invention; and

FIG. 5 is a schematic diagram of an allocation group according to an embodiment of the present invention.

### DETAILED DESCRIPTION OF THE INVENTION

The detailed features and advantages of the present invention are described below in great detail through the following embodiments, the content of the detailed description is sufficient for persons skilled in the art to understand the technical content of the present invention and to implement the present invention there accordingly. Based upon the content of the specification, the claims, and the drawings, persons skilled in the art can easily understand the relevant objectives and advantages of the present invention.

The present relates to a method for processing duplicated data, applicable to a server. The server for implementing the method for the processing duplicated data can be used to back up data of at least one client, and the server can have a data de-duplication function.

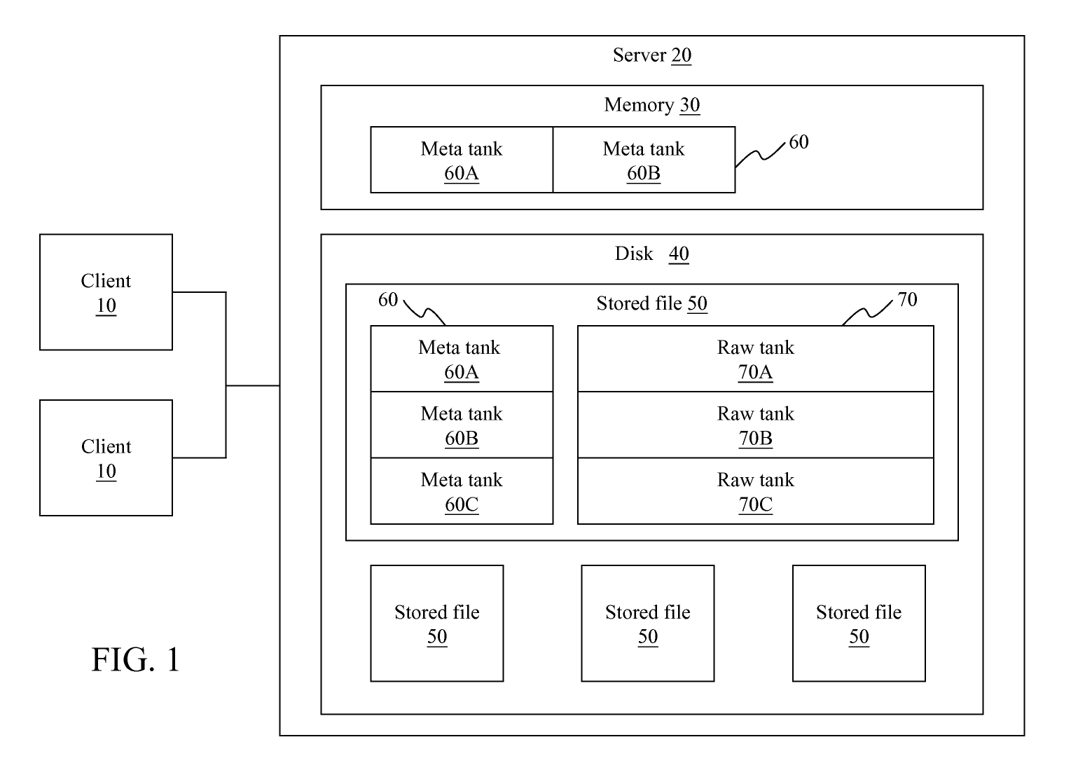

FIG. 1 is a schematic diagram of a server according to an embodiment of the present invention. Referring to FIG. 1, the server 20 can be connected to a plurality of clients 10 through various networks, such as Internet or an internet and back up data transported by the clients 10. The server 20 may have hardware, such as a memory 30, a disk 40 and a processor. The disk 40 stores a plurality of stored files 50 completely received from the clients 10. In the process of processing the stored file 50, data to be processed can be loaded from the disk 40 into the memory 30 for processing.

The stored file 50 may be, for example, a text file, various multimedia files or a snapshot generated when the client 10 performs system backup. A method for processing duplicated data can rapidly determine whether a file to be backed up is one of the stored files 50 in the server 20 when the client 10 intends to perform backup.

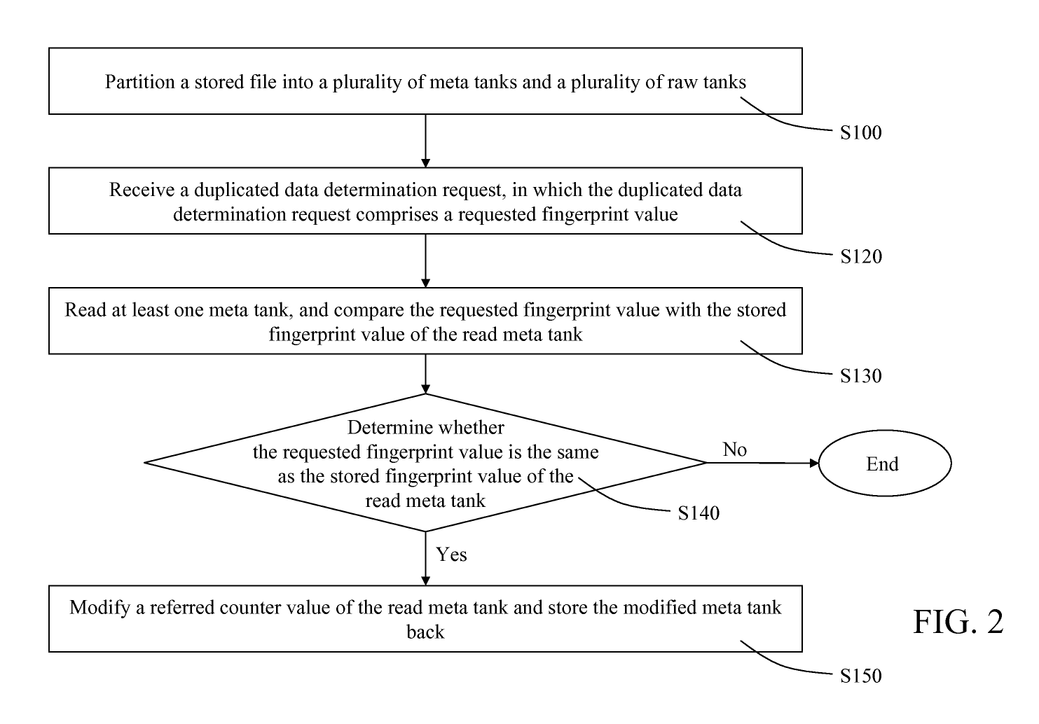

FIG. 2 is a flow chart of a method for processing duplicated data according to an embodiment of the present invention.

Referring to FIG. 2, first, a server 20 partitions a stored file 50 into a plurality of meta tanks 60A, 60B and 60C, and a plurality of raw tanks 70A, 70B and 70C in advance (Step S100). In addition, the meta tanks 60A, 60B and 60C and the raw tanks 70A, 70B and 70C are collectively called the meta tanks 60 and the raw tanks 70 respectively. The meta tanks 60 correspond to the raw tanks 70 in a one to one manner. Each meta tank 60 has a stored fingerprint value of the corresponding raw tank 70. For example, the meta tanks 60A, 60B and 60C may correspond to the raw tanks 70A, 70B and 70C respectively, and the stored fingerprint value of the raw tank 70A exists in the meta tank 60A.

The server 20 may first partition the whole stored files 50 into a plurality of groups of tanks in a manner such as a fixed size partition or content defined chunking (CDC), in which each group of tanks comprises one meta tank 60 and one raw tank 70 corresponding to each other. Then, the paired meta tank 60 and raw tank 70 are individually deposited for the subsequent reading.

However, the server 20 may also partition content of the stored file 50 into the raw tanks 70 first, and then obtain the corresponding meta tanks 60 according to the partitioned raw tanks 70. The server 20 may calculate the stored fingerprint value of each raw tank 70 through an algorithm, such as message digest algorithm 5 (MD5), secure hash algorithm (SHA)-1, SHA-256, SHA-512 or one-way hash, and store the stored fingerprint value in the corresponding meta tank 60.

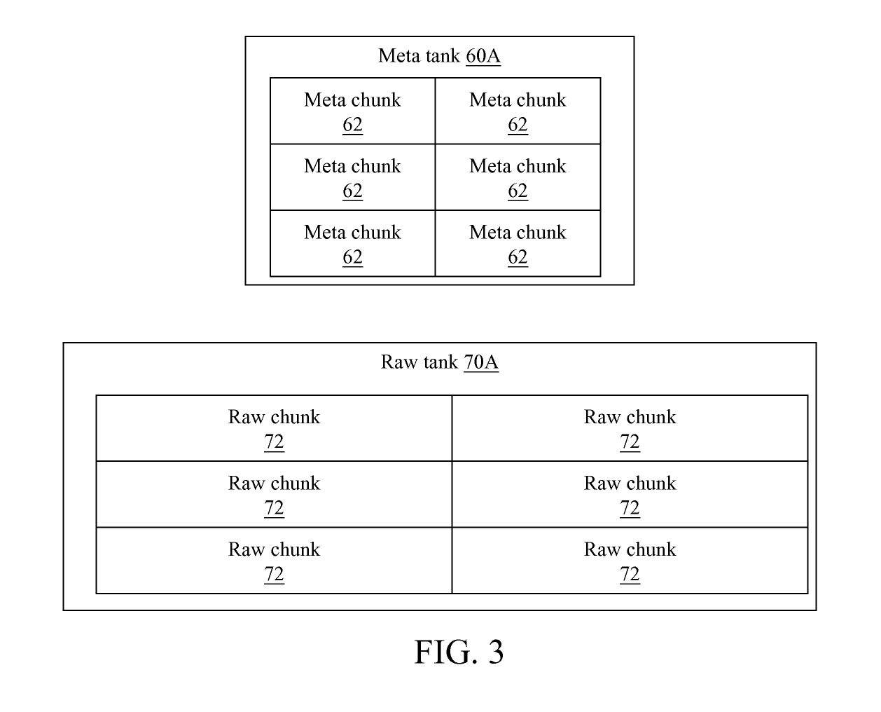

In an embodiment, each raw tank 70 may comprise a plurality of raw chunks 72, as shown in FIG. 3. Accordingly, each meta tank 60 may comprise a plurality of meta chunks 62. The raw chunks 72 also correspond to the meta chunks 62 in the one to one manner. For example, six meta chunks 62 in the meta tank 60A correspond to six raw chunks 72 in the raw tank 70A in the one to one manner.

Taking the fixed-size partition as an example, if a length of each raw chunk 72 is 64 KB, a length of the corresponding meta chunk 62 is 28 bytes, and a length of the raw tank 70 is fixed to 2 MB. It can be calculated that each tank comprises 32 chunks and a length of the meta tank 60 is 896 KB.

Then, the server 20 can receive a duplicated data determination request from any client 10, in which the duplicated data determination request comprises a requested fingerprint value (Step S120). In order to reduce data transmission between the client 10 and the server 20, the client 10 may transport a requested fingerprint value representing a requested tank to the server 20 when intending to back up the requested tank. But an algorithm for calculating the requested fingerprint value according to the requested tank must be the same as an algorithm for calculating the stored fingerprint value according to the raw tank 70.

After receiving the duplicated data determination request, the server 20 reads at least one meta tank 60 of the stored file 50 corresponding to the duplicated data determination request and compares the requested fingerprint value with the stored fingerprint value of the read meta tank 60 (Step S130).

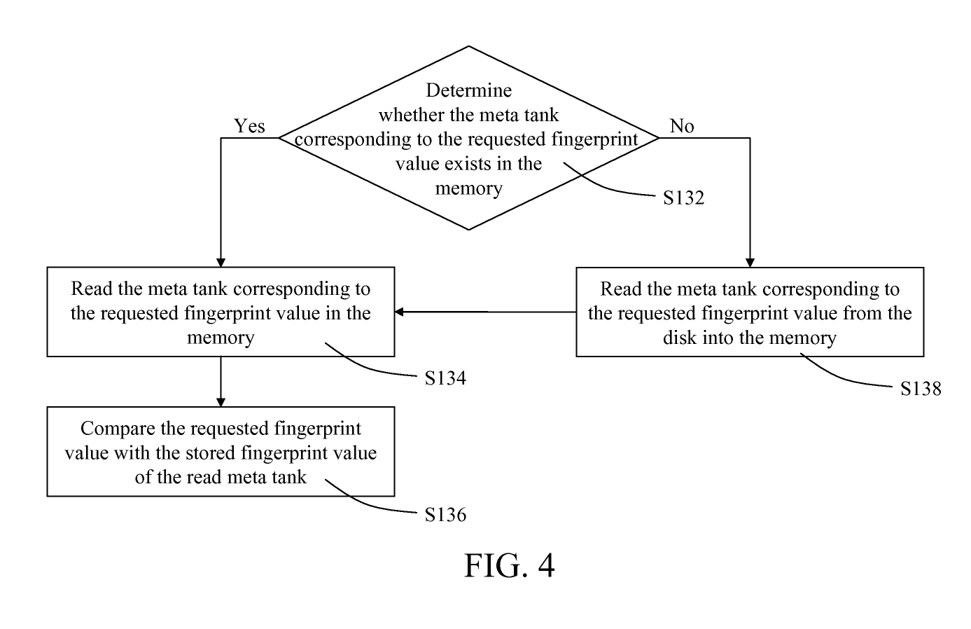

FIG. 4 is a flow chart of Step S130 according to an embodiment of the present invention.

Referring to FIG. 4, the server 20 first determines whether the meta tank 60 corresponding to the requested fingerprint value exists in the memory 30 (Step S132). When the meta tank 60 corresponding to the requested fingerprint value exists in the memory 30, the server 20 may directly read the meta tank 60 corresponding to the requested fingerprint value in the memory 30 (Step S134), and compare the requested fingerprint value with the stored fingerprint value of the read meta tank 60 (Step S136). In contrast, if the meta tank 60 corresponding to the requested fingerprint value cannot be found in memory 30 after search, the meta tank 60 corresponding to the requested fingerprint value is first read from the disk 40 into the memory 30 (Step S138), and then Step S134 and Step S136 are executed.

For example, it is assumed that the meta tank 60C corresponds to the requested fingerprint value. Since the meta tank 60C cannot be found in the memory 30, the meta tank 60C is first loaded into the memory 30. It should be noted that, in Step S138, only the meta tank 60C having an extremely small data length rather than the corresponding raw tank 70C needs to be loaded. When the meta tank 60C is not swapped out of the memory 30 due to insufficient space of the memory 30, if the requested fingerprint value corresponding to the meta tank 60C is received again, the server 20 may directly execute Step S134 and Step S136.

Then, the server 20 determines whether the requested fingerprint value is the same as the stored fingerprint value of the read meta tank 60 (Step S140). When the requested fingerprint value is the same as the stored fingerprint value of the read meta tank 60, which indicates that the requested fingerprint value corresponds to one existing raw tank 70, the requested tank represented by the requested fingerprint value is duplicated data. For the duplicated data, the server 20 only needs to modify a referred counter value of the read meta tank 60 and stores the modified meta tank 60 back (Step S150). The referred counter value represents the times for referring to the corresponding raw tank 70. The same raw tank 70 can be referred to by the same client 10 for many times or can be referred to by different clients 10 simultaneously. The modified meta tank 60 is stored back in the disk 40.

If the stored file 50 or the meta tank 60 corresponding to the requested fingerprint value cannot be found in Step S130, the requested tank corresponding to the requested fingerprint value is a new tank rather than the duplicated data. The server 20 can execute an addition procedure to demand the client 10 to transmit the requested tank and add the received requested tank into the disk 40.

When the requested fingerprint value is different from the stored fingerprint value of the read meta tank 60, a hash collision occurs. The server 20 can re-search the memory 30 or the disk 40 for whether the stored file 50 or the meta tank 60 corresponding to the requested fingerprint value exists in a manner of looking up a hash collision table, and determine whether Step S130 to Step S150 are executed.

It should be noted that, it is taken as an example that the meta tank 60 of a single stored file 50 is searched for the requested fingerprint value in FIG. 2, but in the method for processing the duplicated data, the plurality of stored files 50 may also be searched for the meta tank 60 corresponding to the requested fingerprint value.

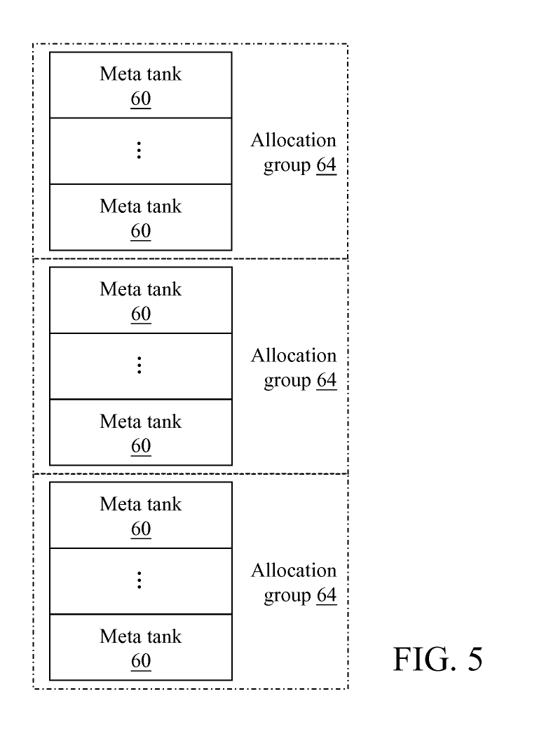

Moreover, the server 20 may further regard some successive meta tanks 60 as an allocation group and regard the allocation group as a unit for accessing the meta tanks 60. FIG. 5 is a schematic diagram of an allocation group according to an embodiment of the present invention.

Referring to FIG. 5, the server 20 may regard the plurality of successive meta tanks 60 as one of the allocation groups 64, load the whole allocation group 64 into the memory 30 one time, and then read at least one meta tank 60. In Step S130, the server 20 may first read at least one allocation group 64, and then compare the requested fingerprint value with the stored fingerprint value of the meta tank 60 in the read allocation group 64. In Step S150, the allocation group 64 corresponding to the whole modified meta tank 60 may also be stored back one time.

A data size of the allocation group 64 may be a positive integer multiple of 16 KB, for example, 16 KB, 64 KB or 128 KB. The data size of the allocation group 64 can be selected according to a disk sector. In the case that a server 20 having a disk sector of 64 KB is taken as an example, the unit of single data input/output (IO) is 64 KB. Therefore, the plurality of meta tanks 60 is assembled into one allocation group 64 through the setting according to the disk sector, so a maximal quantity of meta tanks 60 can be read or written during single disk IO. In this way, it can be avoided that data of 64 KB is read or written for a single meta tank 60 of a size of only 3 k each time.

In conclusion, in the method for processing the duplicated data, when it is determined whether the requested tank corresponding to the requested fingerprint value exists, only the corresponding meta tank needs to be loaded into the memory. In this way, the server needs not to load the whole relevant meta tank and raw tank into the memory, thereby conserving a large amount of disk IO time. For the numerical value in the foregoing embodiment, in the method for processing the duplicated data, only the meta tank of 3 KB needs to be loaded to perform determination, and the unavailable raw tank of 2 MB needs not to be loaded into the disk.

Furthermore, in the method for processing the duplicated data, the allocation group can be set according to the disk sector, and the plurality of successive meta tanks can be accessed one time. Therefore, for services, such as full backup for a large number of files or tanks, because of highly successive requested tanks, the way of loading the plurality of successive meta tanks one time can increase a hit rate of search, and the required times of disk IO is further reduced. Furthermore, since the data length of the meta tank is small, in the method for processing the duplicated data, the server may also provide the stored fingerprint value for comparison for the client, and each client performs the steps of comparison and data de-duplication.

What is claimed is:

1. A method for processing duplicated data, comprising:
partitioning a stored file into a plurality of raw tanks and a plurality of meta tanks, wherein the raw tanks correspond to the meta tanks in a one to one manner, and each meta trank has a stored fingerprint value of the corresponding raw tank;
receiving a duplicated data determination request, wherein the duplicated data determination request comprises a requested fingerprint value;
reading at least one of the meta tanks, and comparing the requested fingerprint value with the stored fingerprint value of the read meta tank; and
modifying a referred counter value of the read meta tank, and storing the modified meta tank back, when the requested fingerprint value is the same as the stored fingerprint value of the read meta tank.

2. The method for processing the duplicated data according to claim 1, wherein each raw tank comprises a plurality of raw chunks, each meta tank comprises a plurality of meta chunks, and the raw chunks correspond to the meta chunks in the one to one manner.

3. The method for processing the duplicated data according to claim 1, wherein the stored file is stored in a disk of a server, and the modified meta tank is stored back in the disk.

4. The method for processing the duplicated data according to claim 3, wherein the step of reading the at least one meta tank and comparing the requested fingerprint value with the stored fingerprint value of the read meta tank comprises:
determining whether the meta tank corresponding to the requested fingerprint value exists in a memory; and
when the meta tank corresponding to the requested fingerprint value exists in the memory, reading the meta tank corresponding to the requested fingerprint value in the memory, and comparing the requested fingerprint value with the stored fingerprint value of the read meta tank.

5. The method for processing the duplicated data according to claim 4, wherein the step of reading the at least one meta tank and comparing the requested fingerprint value with the stored fingerprint value of the read meta tank comprises:
when the meta tank corresponding to the requested fingerprint value does not exist in the memory, reading the meta tank corresponding to the requested fingerprint value from the disk into the memory, and comparing the requested fingerprint value with the stored fingerprint value of the read meta tank.

6. The method for processing the duplicated data according to claim 1, wherein some meta tanks is regarded as an allocation group, and the step of reading the at least one meta tank and comparing the requested fingerprint value with the stored fingerprint value of the read meta tank comprises:
reading at least one of the allocation group; and
comparing the requested fingerprint value with the stored fingerprint values of the meta tanks in the read allocation group.

7. The method for processing the duplicated data according to claim 6, wherein a data size of the allocation group is a positive integer multiple of 16 KB.

8. The method for processing the duplicated data according to claim 6, wherein the step of modifying the referred counter value of the read meta tank and storing the modified meta tank back comprises:
modifying the referred counter value of the read meta tank and storing the allocation group corresponding to the modified meta tank back.
